(19) United States
(12) Patent Application Publication
(10) Pub. No.: US 2014/0123861 A1
(43) Pub. Date: May 8, 2014

(54) ADJUSTABLE COOKING DEVICE

(71) Applicant: ACCUTEMP PRODUCTS, INC., Fort Wayne, IN (US)

(72) Inventors: Lawrence E. Cooper, Fort Wayne, IN (US); Gary L. Seitz, Decatur, IN (US)

(21) Appl. No.: 13/796,789

(22) Filed: Mar. 12, 2013

Related U.S. Application Data
(60) Provisional application No. 61/723,187, filed on Nov. 6, 2012.

(51) Int. Cl. A47J 37/06

(52) U.S. Cl. CPC A47J 37/0611
USPC 99/374; 99/372; 99/379

(57) ABSTRACT

A cooking apparatus facilitates efficient, consistent cooking of superior food products, while also being modular and flexible for use in a wide variety of kitchen arrangements and cooking scenarios. The cooking apparatus may include a variety of features and enhancements to further these goals, including: a steam barrier which prevents the escape of steam from the cooking surfaces during cooking; adjustable cooking surface spacers that ensure desired spacing between the cooking surfaces; a vertically adjustable upper platen that facilitates efficient use and placement of the cooking apparatus; and discrete lower platen cooking surfaces which facilitate multiple cooking processes depending on the needs of the user.

### CROSS REFERENCE TO RELATED APPLICATIONS

The present application claims the benefit under Title 35, U.S.C. Section 119(e) of U.S. Provisional Patent Application Ser. No. 61/723,187, filed Nov. 6, 2012 and entitled ADJUSTABLE COOKING APPLIANCE, the entire disclosure of which is hereby expressly incorporated herein by reference.

### BACKGROUND

1. Technical Field

The present disclosure relates to heated cooking devices, and more particularly, to a griddle having a heated platen that is modularly adjustable to optimize cooking of foods near the platen.

2. Description of Related Art

Cooking appliances designed for high throughput of foods prepared on a griddle are common in the restaurant industry. One type of high-throughput griddle is known as a “clam shell” griddle, which has a lower heated platen providing a lower cooking surface, and an upper heated platen providing an opposed upper cooking surface. The upper platen may be configured into a cooking position, in which the upper platen heated surface is spaced away from the lower platen heated surface by a desired distance, such that food to be cooked is captured between the upper and lower platens and is cooked from both the top and the bottom surfaces when the platens are heated.

Clamshell griddles are one example of cooking appliances that can be used to cook two sides of a food product simultaneously. Some clamshell griddles use a hinged upper platen, which can be raised and lowered by pivoting the upper platen about the hinge, so as to bring a top cooking surface into proximity with the food product to be cooked. In some cases, such hinges may be designed to produce and/or maintain a desired distance between the top cooking surface and a particular food product, such that the top cooking surface transmits a desired amount of energy to the food while preventing the full weight of the upper platen from resting upon the food product.

When food products are cooked in such appliances, the elevated temperature causes the moisture contained within the food to vaporize or otherwise releases such moisture as liquid, vapor or steam. The heating of the contained moisture contributes to the cooking of the food as the hot moisture permeates the food substance and transfers its heat to the food, thus raising the internal temperature of the food and commencing the cooking process.

However, if the moisture escapes the cooking area, the food product will dry out, which in turn slows the cooking process and may render the food product dry and/or less palatable. In some cases, a food depleted of moisture may have only its outer layer cooked, because inadequate moisture is not able to carry heat to the interior of the product. This, in turn, may lead to an overcooked exterior while leaving an undercooked interior.

In a restaurant setting, the location of cooking appliances is also a consideration. For example, high-volume restaurant operations may seek to maximize efficiencies by placing certain cooking appliances in close proximity to the storage units used to store the foods cooked on the cooking appliances, thereby reducing the need for the operator to move around the cooking area during food preparation.

Cooking apparatuses that efficiently produce high-quality results are desirable.

### SUMMARY

The present disclosure provides a cooking apparatus that facilitates efficient, consistent cooking of superior food products, while also being modular and flexible for use in a wide variety of kitchen arrangements and cooking scenarios. The cooking apparatus may include a variety of features and enhancements to further these goals, including: a steam barrier which prevents the escape of steam from the cooking surfaces during cooking; adjustable cooking surface spacers that ensure desired spacing between the cooking surfaces; a vertically adjustable upper platen that facilitates efficient use and placement of the cooking apparatus; and discrete lower platen cooking surfaces which facilitate multiple cooking processes depending on the needs of the user.

In one form thereof, the present disclosure provides a cooking appliance including: a first platen having a first platen cooking surface; a second platen having a second platen cooking surface opposed to and spaced from the first platen cooking surface to define a cooking space between the mutually opposed first and second cooking surfaces; a heating element in at least one of the first platen and the second platen; and a skirt assembly connected to the first platen and arranged at a periphery of the cooking space, the skirt assembly extending away from the first platen cooking surface toward the second platen cooking surface, whereby the skirt assembly operates as a barrier to escape of steam from the cooking space.

In another form thereof, the present disclosure provides a cooking appliance including: an upper platen having an upper platen cooking surface; a lower platen having a lower platen cooking surface opposed to and spaced from the upper platen cooking surface to define a cooking space between the mutually opposed upper and lower cooking surfaces; a heating element in at least one of the upper platen and the lower platen; and a spacer adjustably attached to the upper platen and extending downwardly past the upper platen cooking surface toward the lower platen cooking surface, the spacer adjustable to a first position and a second position, the spacer defining a first cooking space size in the first position and a second cooking space size in the second position, the first cooking space size different from the second cooking space size.

In another form thereof, the present disclosure provides a cooking appliance including: an upper platen having an upper platen cooking surface; a lower platen having a lower platen cooking surface facing the upper platen cooking surface, the upper and lower platen cooking surfaces spaced from and substantially parallel to one another to define a cooking space therebetween; a heating element in at least one of the upper platen and the lower platen; and a vertical actuator operably connected to the upper platen, the vertical actuator operable to raise and lower the upper platen along a vertical path while maintaining the upper and lower platen cooking surfaces in the substantially parallel configuration.

In yet another form thereof, the present disclosure provides a cooking appliance including: a support structure having a work top made of a monolithic material; a plurality of lower platens supported on or in the work top and spaced from one another, the plurality of lower platens each having a lower platen cooking surface, the work top thermally isolating the plurality of lower platens from one another; a plurality of upper platens each having an upper platen cooking surface respectively opposed to and spaced from one of the plurality of lower platen cooking surfaces to define a plurality of discrete, thermally isolated cooking spaces between respective pairs of opposed upper and lower cooking surfaces; and a heating element in at least one of the upper platen and the lower platen for each of the respective pairs of opposed upper and lower cooking surfaces.

### BRIEF DESCRIPTION OF THE DRAWINGS

FIG. 1 is a perspective view of a clamshell-type commercial food griddle having steam containment and cooking surface spacing features in accordance with the present disclosure;

FIG. 2 is a perspective view of the commercial food griddle shown in FIG. 1;

FIG. 3A is an exploded, perspective view of an upper platen assembly used in the commercial food griddle of FIG. 1;

FIG. 3B is an exploded view of a multi-piece steam skirt in conjunction with an upper platen assembly made in accordance with the present disclosure;

FIG. 3C is an exploded view of the multi-piece steam skirt shown in FIG. 3B;

FIG. 3D is an exploded view of a single-piece steam skirt in conjunction with an upper platen assembly made in accordance with the present disclosure;

FIG. 3E is an exploded view of the single-piece steam skirt shown in FIG. 3D;

FIG. 3F is an exploded view of a flexible steam skirt in conjunction with an upper platen assembly made in accordance with the present disclosure;

FIG. 3G is an exploded view of the flexible steam skirt shown in FIG. 3F;

FIG. 4 a partial perspective view of a portion of the food griddle shown in FIG. 1, illustrating a cooking surface spacer made in accordance with the present disclosure;

FIG. 5 is a partial perspective view of a portion of the food griddle shown in FIG. 1, illustrating a steam skirt made in accordance with the present disclosure;

FIG. 6A is an exploded, perspective view of an upper platen frame unit made in accordance with the present disclosure;

FIG. 6B is a side elevation, cross-section view of a top plate of an assembled frame unit shown in FIG. 6A; and

FIG. 7 is a perspective view of a cooking apparatus utilizing vertically moveable upper platens and discrete lower platens in accordance with the present disclosure.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The present disclosure provides a cooking apparatus which incorporates one or more features to provide consistent and improved cooking results and/or improved, modular functionality, particularly in a high-throughput kitchen environment. The features which may be incorporated into the present cooking apparatus include steam-retention skirt arrangements, spacers to maintain appropriate distance between the upper and lower cooking surfaces, vertically moveable upper platens, discrete lower platens within a single cooking unit, or any combination thereof

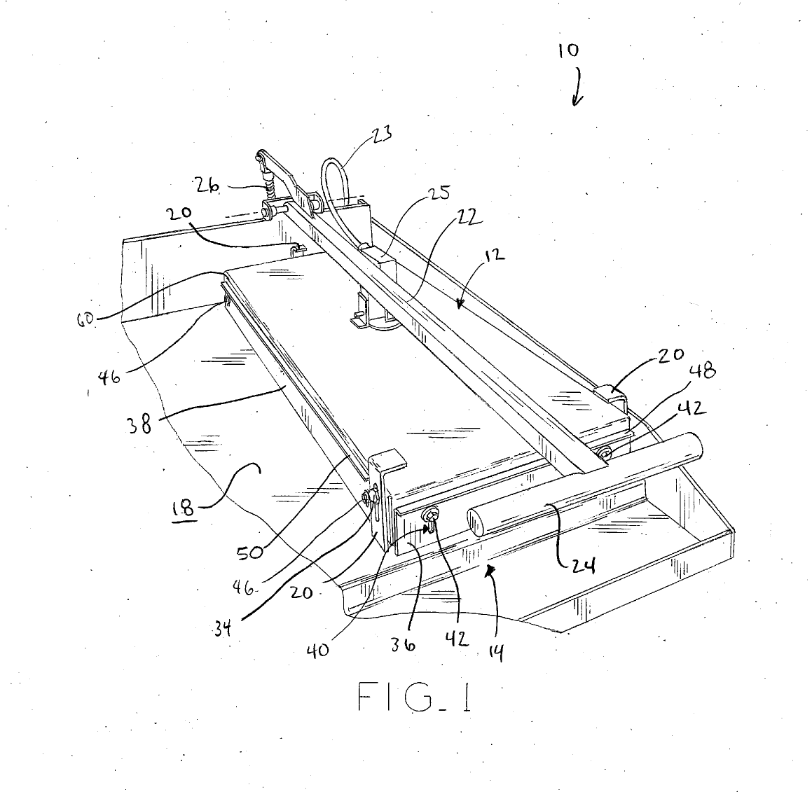

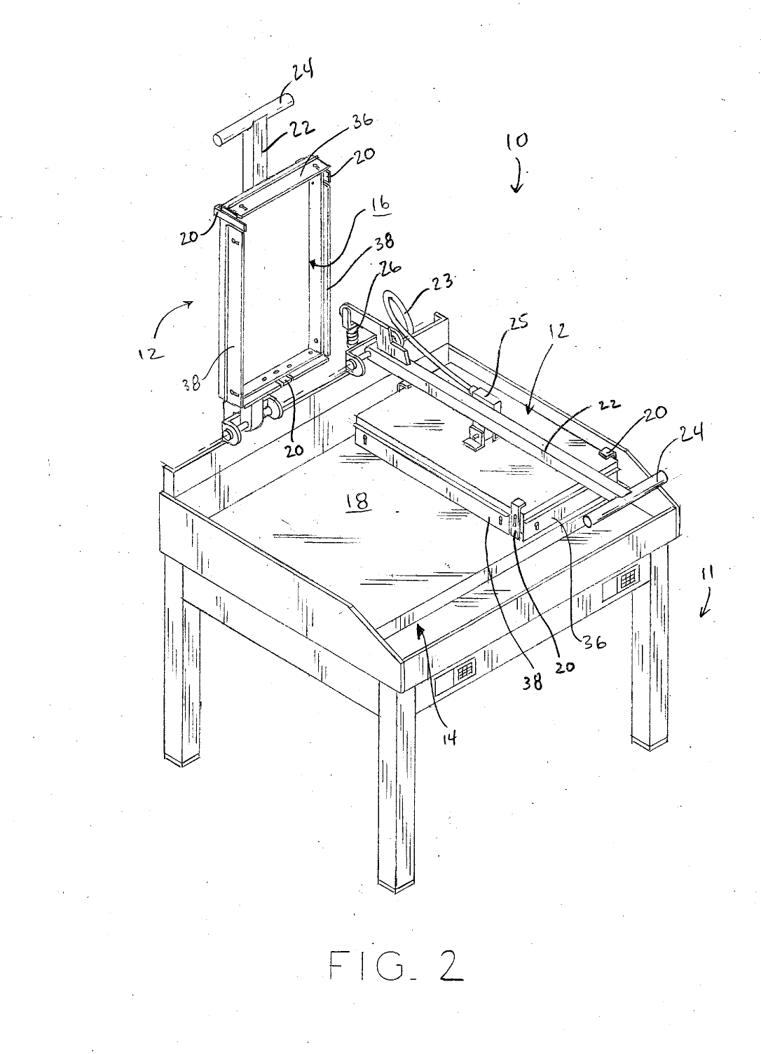

FIGS. 1 and 2 illustrate cooking appliance 10 having upper platen assembly 12 and lower platen 14 supported upon cooking stand 11, each of which have a respective heating surface 16, 18 (FIG. 2) oriented to face one another when upper platen assembly 12 is in the closed configuration as shown in FIG. 1. Upper platen assembly includes a platen, such as a heating plate, which defines upper heating surface 16. In FIG. 2, two upper platen assemblies 12 are shown with the left platen assembly 12 in the open configuration, and the right platen assembly 12 in the closed configuration. In this embodiment, lower platen 14 is wide enough to span both upper platen assemblies 12, though it is contemplated that discrete lower platens 14 may be provided as shown in FIG. 7 and described in detail below.

For purposes of the present disclosure, the open configuration is one in which the cooking space is substantially unbounded, that is, heating surfaces 16, 18 are not facing one another and/or sufficiently close to one another to mutually impart sufficient heat to one another to cause cooking of food. In contrast, the closed configuration is one in which heating surfaces 16, 18 define a bounded cooking space therebetween because surfaces 16, 18 are facing one another and close enough to one another to mutually impart heat to food in the cooking space and to one another, in an amount sufficient to cause cooking of the food. In an exemplary embodiment, the spacing between heating surfaces 16 and 18 in the closed configuration may be as little as 0.05 inches, 0.06 inches, 0.5 inches or 1 inch, or may be as large as 2 inches, 4 inches or 6 inches, or may be any value within any range defined by any of the foregoing values.

When upper platen assembly 12 is in the closed configuration, food items contained in the cooking space between upper and lower platens 12, 14 are heated and cooked by one or more heating elements contained in upper platen 12, lower platen 14, or both. The heating elements are arranged behind the respective inwardly facing heating surfaces 16, 18, and may take a number of forms as required or desired for a particular application. For example, the heating elements may be serpentine tubes with heated fluid circulating there through to impart heat to heating surfaces 16, 18. Alternatively, a gas or oil-fired burner or electric heating element may be provided to heat heating surfaces 16, 18, for example. Moreover, any heating element may be provided to heat a metal plate at one or both of upper and lower heating surfaces 16, 18, or may directly heat a food product by transmitting energy and/or radiation by conduction, convection or electromagnetic radiation. In the exemplary embodiment of FIG. 1, a heating element contained within upper platen assembly 12 may receive heat energy (e.g., electrical energy, hot fluid such as steam, or the like) through heating conduit 23 which extends from a heat energy source to manifold block 25 and then to the heating element itself.

### 1. Platen Spacer Arrangement

Cooking appliance 10 includes a plurality of spacers 20 configured to hold upper platen assembly 12 at a particular desired height above lower platen 14 when in the closed position, thereby setting a precise and repeatable distance between upper and lower heating surfaces 16, 18.

In the illustrated embodiment, upper cooking platen 12 is mounted on a platen support beam 22 that supports upper cooking platen 12. Support beam 22 can be manually raised and lowered, thereby raising or lowering upper platen assembly 12, by lifting or lowering handle 24. In an exemplary embodiment, the lifting operation may be assisted by springs, and/or air or hydraulic cylinders, such as assist cylinder 26.

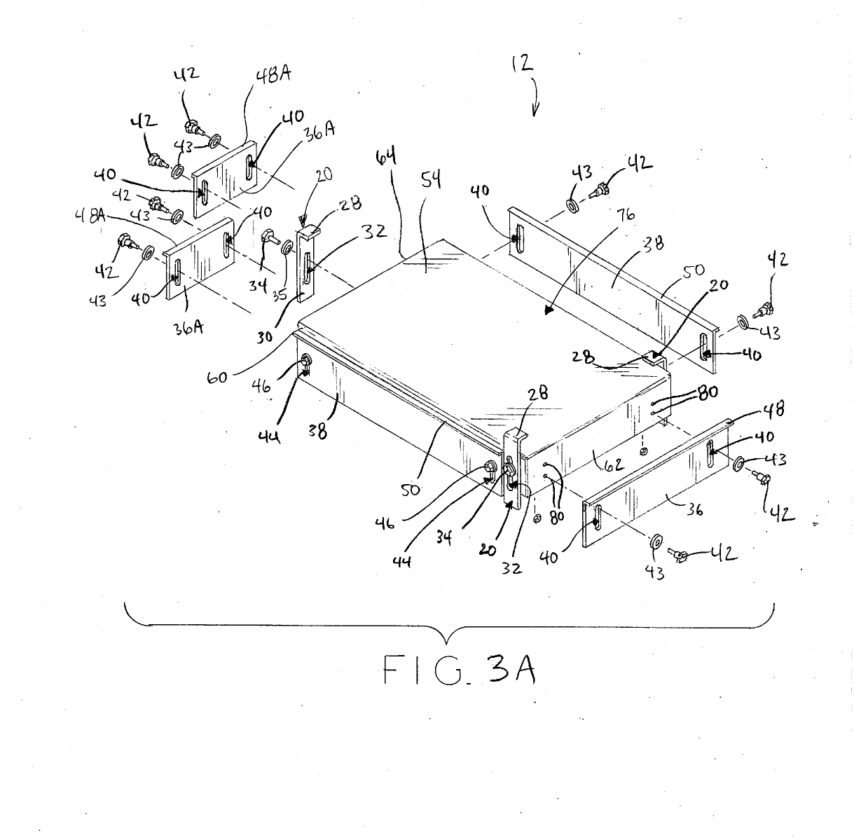

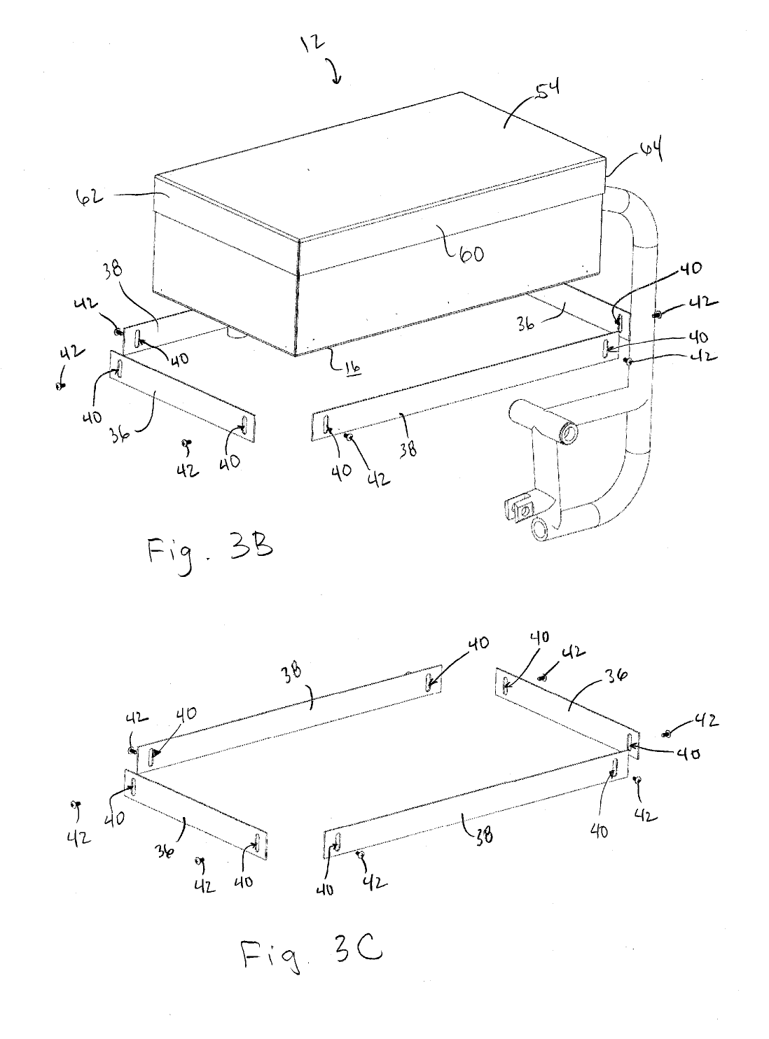

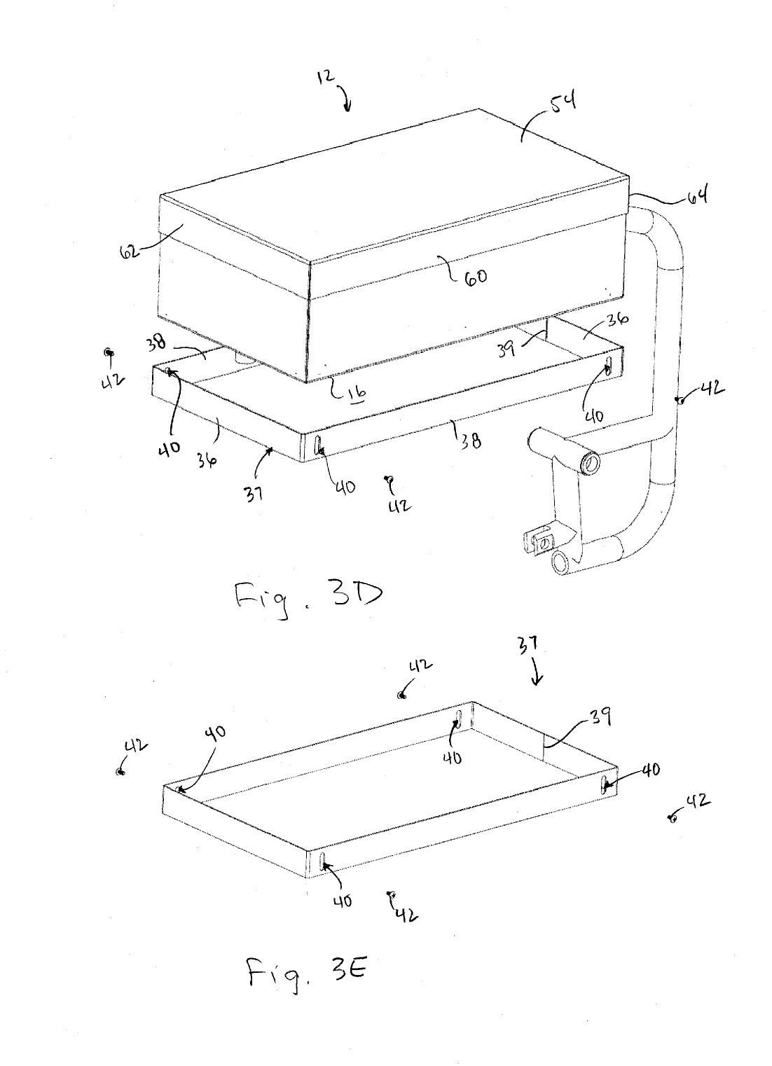

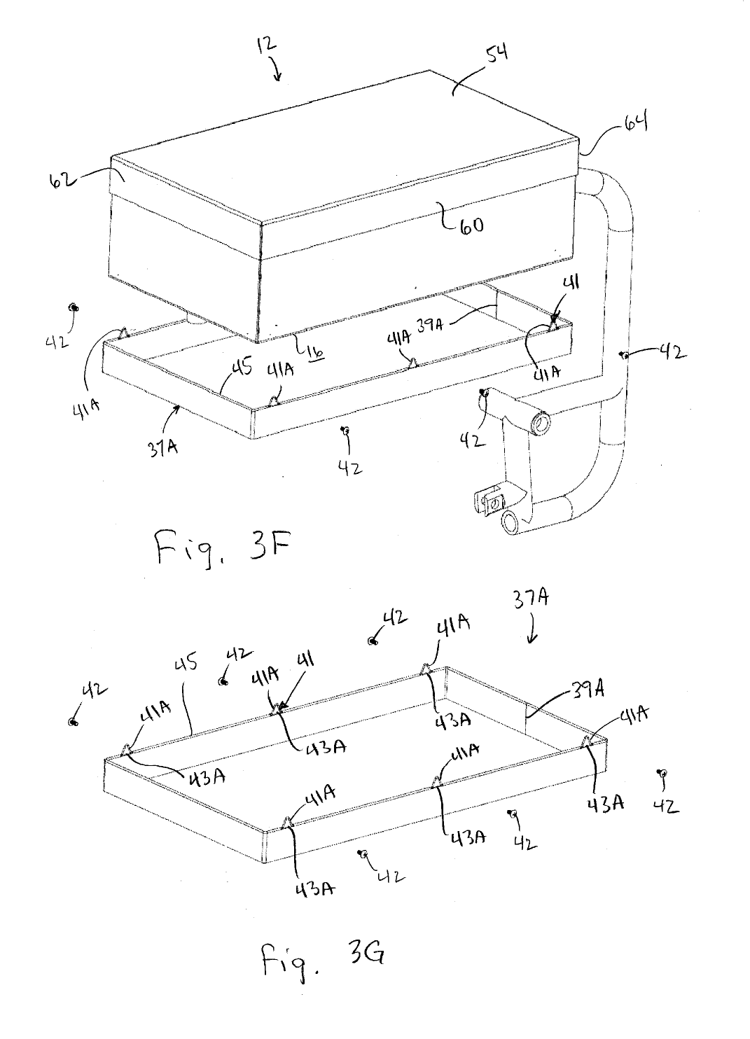

When upper cooking platen 12 is in the lowered, cooking position shown in FIG. 1, upper heating surface 16 (FIG. 2) is held at a predetermined height above lower heating surface 18 by a stable three point support system provided by three spacers 20 spaced apart from one another about the periphery of upper platen assembly 12. This predetermined height allows for proper and predictable cooking of the food contained in the cooking space between upper and lower heating surfaces 16, 18. In the exemplary illustrated embodiment, first and second spacers 20 are located at opposing lateral sides of upper platen assembly 12 and adjacent the proximal-end surface of upper platen assembly 12, i.e., near the surface defined by proximal plate 62 shown in FIG. 3A, which is nearest to the operator when cooking appliance 10 is in use. A third spacer 20 is centered on the distal-end surface of platen 12, i.e., on the surface defined by distal plate 64, which is furthest from the operator when cooking appliance 10 is in use.

This three-spacer arrangement ensures that upper platen assembly 12 will be stably, precisely supported above lower platen 14. Moreover, because three points of contact are the minimum to define a plane, the provision of exactly three spacers 20 ensures that all spacers 20 will be in firm and stable contact with heating surface 18 of lower platen 14. In addition, the positioning of spacers near the lateral ends of the proximal-end surface and centered on the distal-end surface of upper platen assembly 12 maximizes the cumulative distance between the three spacers 20, thereby maximizing stability of upper platen assembly 12.

In an exemplary embodiment, the plane defined by the end surfaces of spacers 20 (i.e., the surfaces of respective extensions 30 which bear against heating surface 18) is substantially parallel to upper heating surface 16. This parallel configuration ensures that heating surfaces 16, 18 are parallel to one another when upper platen assembly 12 is in the closed position. It also ensures that the spacing between upper and lower heating surfaces 16, 18 is consistent across the areas of each cooking surface, which in turn promotes uniformity of cooking performance within the cooking space. As noted above, an exemplary embodiment of cooking appliance 10, utilizes spacing between upper and lower heating surfaces 16, 18 when upper platen 12 is in the closed position which may be as little as 0.05 inches, 0.06 inches, 0.5 inches or 1 inch, or may be as large as 2 inches, 4 inches or 6 inches, or may be adjustable to any value within any range defined by any of the foregoing values.

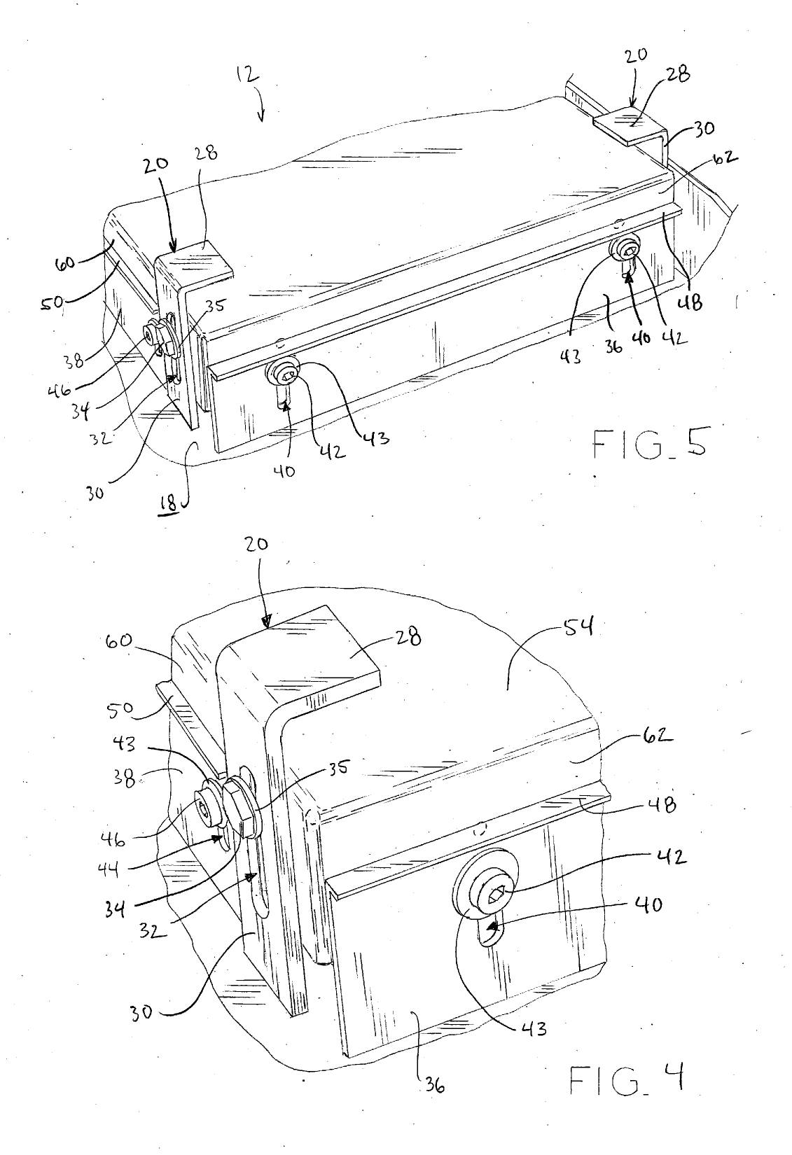

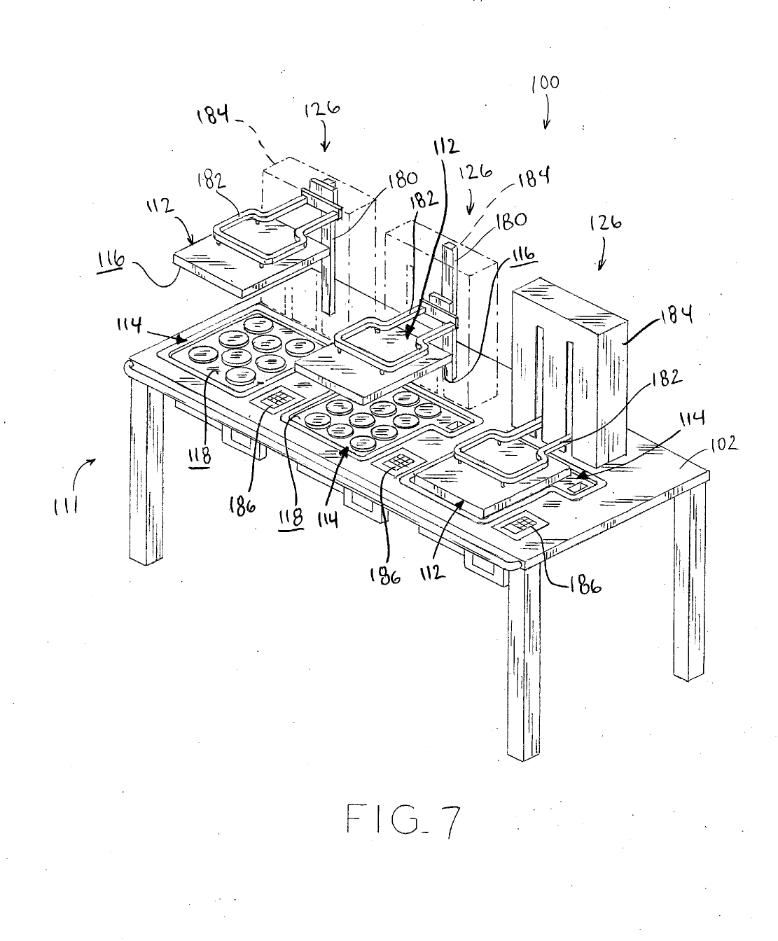

FIG. 4 illustrates an exemplary embodiment of spacer 20. Spacer 20 is, in the exemplary embodiment illustrated, an L-shaped bracket having base 28 and extension 30. Base 28 is optional. Elongate slot 32 is formed along the length of extension 30, and provides continuous vertical adjustability of spacer 20 to determine spacing between upper and lower heating surfaces 16, 18. As best shown in FIG. 3A, fastener 34 is passed through slot 32 and into aperture 82 of side plate 60 (FIG. 6A) to affix spacer 20 to upper platen assembly 12 at a desired vertical location, depending on where fastener 34 is within slot 32 upon fixation. More particularly, the shaft of fastener 34 is passed through slot 32 such that the head of the fastener bears against the surface to either side of slot 32. When fastener 34 is tightened in this configuration, frictional interaction between the head of fastener 34 and the surfaces adjacent to slot 32 prevents any movement of spacer 20 with respect to fastener 34. Optionally, a washer 35 may be interposed between the head of fastener 34 and the surfaces adjacent slot 32 to expand the contact area therebetween and thereby increase the friction fixation. When fastener 34 is loosened, this friction is reduced and spacer 20 can be slid up and down as fastener 34 moves within slot 32. In one exemplary embodiment, spacer 20 may include detents and/or a scale marked on the outer face of extension 30 to provide the user with precise vertical adjustability. Base 28 may be used as a grasping handle during the adjustment process.

In another exemplary embodiment, the vertical adjustment of spacers 20 may be effected automatically, such as by actuating a pneumatic cylinder, motor or other actuator operably connected to spacer 20. Automatic adjustment can be made by the operator (either by manual or automatic adjustment modalities), or can be automated using a controller having a microprocessor receiving input from one or more sensors. For example, sensors may send signals to the controller indicative of the temperature of one or both of heating surfaces 16, 18, the electromagnetic radiation being imparted to the cooking area, the humidity of the cooking area, or any combination of these parameters. In some cases, a controller may include programming to lower spacers 20 (thereby expanding the heating volume) in response to a high-limit condition from a temperature sensor within the cooking area.

In an exemplary embodiment, spacer 20 is made from stainless steel, though any material may be used provided it is sufficiently heat-resistant for the particular application and otherwise suitable for cooking, while also being strong enough to support the weight of the upper platen in the application.

### 2. Efficiency Skirt

As illustrated in FIGS. 1-3, cooking appliance 10 also includes a set of efficiency skirts 36, 38 positioned around the periphery of upper platen assembly 12 and arranged to prevent excessive escape of steam from the cooking space between heating surfaces 16, 18 during a cooking process. End-surface efficiency skirts 36 are elongated plates having a length substantially equal to the proximal and distal end surfaces of upper platen assembly 12, as shown. Lateral side surface efficiency skirts 38 are similarly constructed to skirts 36, as elongate plates with a length substantially equal to the lateral side surfaces of upper platen assembly 12. In addition, the spacing between skirts 36, 38 and the adjacent side surfaces of upper platen assembly 12 is, in certain embodiments, maintained at a minimum (such as a fraction of an inch) to retain steam and heat within the cooking area, while also allowing relative movement between skirts 36, 38 and upper platen assembly 12 as described below. For example, contact between skirts 36, 38 and the respective abutting faces of upper platen assembly 12 may be maintained throughout movement and operation of skirts 36, 38, while contact pressures resulting from such contact are kept sufficiently low to permit such movement.

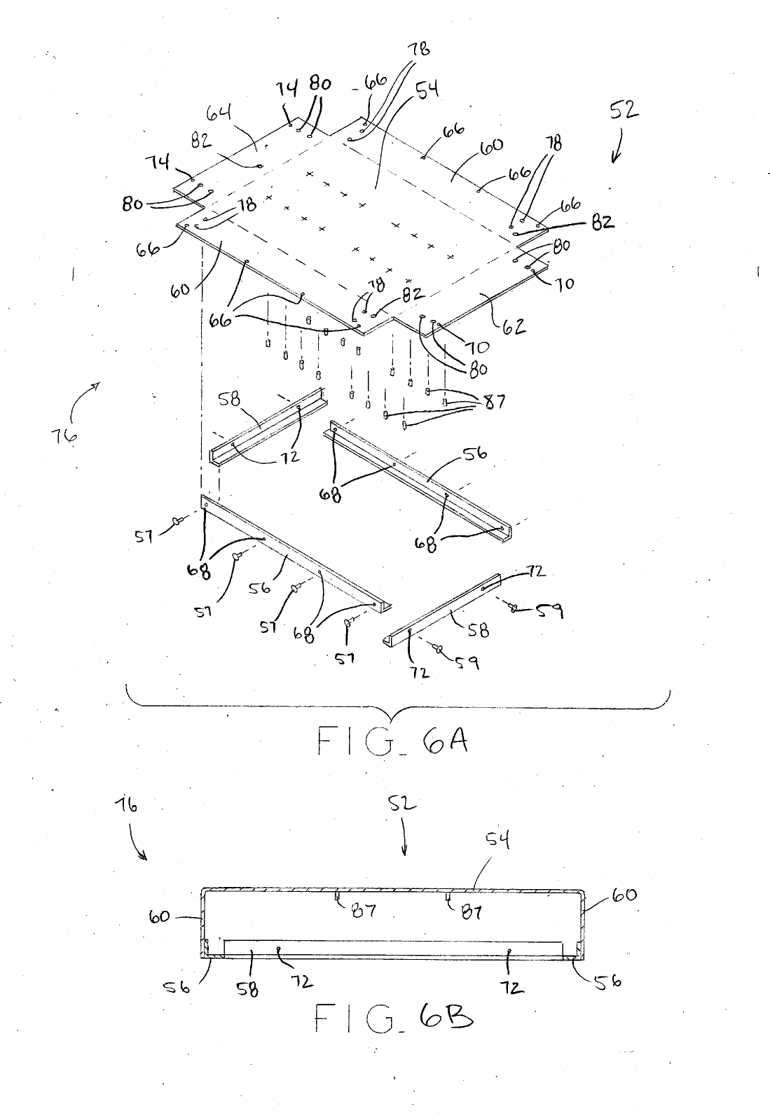

As best shown in FIG. 5, a pair of slots 40 are formed in skirt 36 having an elongate dimension substantially perpendicular to the longitudinal length of skirt 36, and therefore also to the lower edges or surfaces of skirts 36, 38 which contact lower heating surface 18 when upper platen assembly 12 is in the closed configuration. This perpendicular arrangement allows skirts 36, 38 to move upwardly and downwardly without any lateral translation, although it is appreciated that non-perpendicular and/or arcuate slots may be used in some designs. Slots 40 have fasteners 42 received therein (FIG. 5), which slidably attach skirt 36 to the adjacent proximal and distal-end surfaces of platen 12. Washers 43 may be interposed between fasteners 42 and skirt 36 to provide additional surface area contact and thereby minimize the potential for binding as skirt 36 slides. In an exemplary embodiment, fasteners 42 are shoulder bolts which, when fully engaged with platen 12, still allow skirt 36 to slide freely with respect to upper platen assembly 12 as fasteners 42 slide within slots 40. Thus, when upper platen assembly 12 is lowered into its closed position and skirt 36 comes into contact with lower heating surface 18 of lower platen 14, skirt 36 is allowed to “float” upwardly as necessary to allow upper platen assembly 12 to be fully lowered (e.g., to the position where spacers 20 contact heating surface 18 as discussed above). This floating configuration ensures that skirt 36 will be in firm and consistent contact with heating surface 18 when upper platen assembly 12 is in the lowered position, thereby preventing escape of steam and heat from the cooking area. When upper platen assembly 12 is again lifted, gravity causes skirt 36 to move down to the end of its vertical travel (i.e., the point at which fastener 42 reaches the upper end of slot 40).

Because spacers 20 are provided in the exemplary embodiment illustrated in FIGS. 1 and 3, skirt 36 need not support any weight other than its own weight, thereby allowing the material of skirt 36 to be made relatively thin. However, it is contemplated that skirt 36 may be fixed to upper platen assembly 12 at a desired vertical position, such as by using traditional fasteners to frictionally fix skirt 36 to upper platen assembly 12. When so fixed, skirt 36 can perform the spacing function of spacers 20 discussed above.

Side skirts 38 are disposed at the lateral sides of upper platen assembly 12, as best shown in FIG. 3A. Skirts 38 are constructed and function substantially the same as skirts 36 disposed at the distal and proximal end surfaces of upper platen assembly 12, except that side skirts 38 are longer to accommodate the longer lateral sides of platen 12. Side skirts 38 include slots 44 through which fasteners 46 pass (FIG. 3A). As a set of four skirts positioned at the periphery of platen 12, skirts 36, 38 substantially enclose the cooking volume between upper and lower heating surfaces 16, 18 to prevent escape of steam released from food contained within the cooking volume.

In some instances, side skirts 38 may be foreshortened in the area of spacers 20, so as to avoid any overlap between skirts 38 and spacers 20. In these cases, spacers 20 cooperate with skirts 38 to retain steam and heat in the cooking space. However, it is also contemplated that skirts 38 can overlap spacers 20, such as by placing an outwardly extending stud at side 60 through which slots 44 are passed upon assembly of skirt 38 to upper platen assembly 12. A backing nut can then be attached to the stud, against which spacer 20 can bear for fixation to upper platen assembly 12 while still allowing skirt 38 to move up and down as described above. Alternatively, a large slot may be formed in skirts 36, 38 or side plates 60 to allow the entirety of spacer 20 to pass there through while still permitting movement of skirts 36, 38.

A similar arrangement may be provided for a distal skirt 36 to accommodate spacer 20 positioned upon distal plate 64, as shown in FIGS. 3B and 3C. In another exemplary embodiment shown in FIG. 3A, two distal skirts 36A are disposed at either side of spacer 20, such that spacer 20 can attach directly to distal plate 64 while also allowing the two distal skirts 36A to move as described above. Distal skirts 36A are otherwise constructed similarly to proximal skirt 36, including slots 40 and lips 48A as described herein.

Optionally, skirts 36, 38 may include horizontally extending lips 48, 50 respectively (FIG. 3A). Lips 48, 50 may be used to manually manipulate skirts 36, 38, such as for raising one or more of skirts 36, 38 to selectively release stem when upper platen assembly 12 is in the lowered position of FIG. 1.

FIG. 6A illustrates an exemplary mounting subframe 52 used for mounting skirts 36, 38 to upper platen assembly 12. Subframe 52 includes top plate 54 with flanges extending therefrom as illustrated. These flanges are bent downwardly to form a right angle with top plate 54, such that side plates 60, proximal plate 62 and distal plate 64 are formed from the planar, not yet bent plate shown in FIG. 6A. Lateral side frame angles 56 are mounted at the interior surfaces of side plates 60, and proximal/distal frame angles 58 are mounted at the interior surfaces of proximal and distal plates 62, 64 to complete subframe 52.

In an exemplary embodiment, side frame angles 56 are provisionally attached to side plates 60 by passing provisional fasteners 57 through apertures 66 and threading fasteners 57 into apertures 68 formed in angles 56. Proximal angle 58 62 is similarly attached to proximal plate via provisional fasteners 59 passed through apertures 70 and threaded into apertures 72, while distal angle 58 is attached to distal plate 64 via provisional fasteners (not shown) also passed through apertures 70, 72. Angles 56, 58 are then welded to plates 60, 62, 64 respectively, thereby creating a stable foundation of support for the bottom surface of mounting subframe 52. In addition, the lateral ends of proximal plate 62 are welded to the proximal ends of side plates 60 to seal the corners formed at these junctions. Similarly, the lateral ends of distal plate 64 are welded to the distal ends of side plates 60 to seal these corners. Finally, the junctions formed by abutting portions of angles 56, 58 may be welded. When the aforementioned welding is complete, a unitary frame weldment structure is created, and the provisional fasteners may be removed. This forms the completed frame structure 76 used in upper platen assembly 12, as best shown in FIG. 3A

As shown in FIG. 3A, for example, it can be seen that the outwardly facing surface of proximal plate 62 forms the proximal end surface of frame structure 76, and therefore also of upper platen assembly 12. Similarly, the outwardly facing surfaces of side plates 60 are the side surfaces of upper platen assembly 12, and the outwardly facing surface of distal plate 64 is the distal surface of upper platen assembly 12. For purposes of the present disclosure, such “outwardly facing” surfaces are those surfaces which face outwardly from the box-like structure of frame structure 76, i.e., the surfaces of plates 60, 62, 64 visible in FIG. 6A.

Referring still to FIG. 6A, side plates 60 include skirt mounting apertures 78 to which fasteners 46 mount for attachment of skirts 38. Similarly, skirt mounting apertures 80 are provided in proximal plate 62 for mounting skirt 36. Side plates 60, and distal plate 64 also include support aperture 82 for mounting spacer 20 via fastener 34, as illustrated in FIG. 3A. Distal plate 64 may also include skirt mounting apertures 80 in the same arrangement as proximal plate 62, if a distal skirt 36 is to be used. However, as illustrated in FIG. 3A, distal skirt 36 may be omitted in some configurations of upper platen assembly 12.

Optionally, weld studs 87 may be welded to an inner surface of top plate 54 in frame structure 76, as illustrated in FIGS. 6A and 6B. Weld studs extend downwardly from this inner surface and provide a plurality of mounting points for a plate to form upper heating surface 16 (which may include a heating element mounted to weld studs 87 and disposed between surface 16 and top plate 54).

Side skirts 38 may have a series of three slots 44 or may have only a pair of slots 44 as shown in FIG. 3A. A single fastener 42, 46 may be used in slots 40, 44, respectively, as shown in FIGS. 1 and 5, or a pair of fastener 42, 46 may be used in each slots 40, 44, respectively as shown in FIG. 3A. Moreover, although the figures illustrate exemplary arrangements and configurations for skirts 36, 38 and the related framing components of upper platen assembly 12, it is contemplated that skirts 36, 38 may be adapted for use in a wide variety of sizes and configurations of cooking apparatuses. In an exemplary embodiment, skirts 36, 38 are made from stainless steel.

As noted above, skirts 36, 38 present a barrier that surrounds and substantially encloses heating surfaces 16, 18 and the resulting cooking volume between surfaces 16, 18 in a manner that captures or retains moisture released from a food product being cooked in cooking appliance 10. This barrier retains the hot vapors and steam released from food products during the cooking process. This retention of hot steam and vapors within close proximity of the food product increases the speed of the cooking process, increases the temperature evenness throughout the food product, facilitates retention of moisture within the cooked food product, improves consistency of timing for cooking a particular food product to a desired temperature, and thereby generally improves the quality and consistency of the cooked food product. These enhancements to temperature evenness and cooking time ensure complete and consistent cooking of food products, thereby killing any bacteria or other pathogens that may be on the surface or within the food product. This, in turn, reduces the potential for food born bacterial illness.

In an alternative embodiment shown in FIGS. 3D and 3E, proximal and distal skirts 36 and side skirts 38 may be combined into a single, unitary skirt 37 surrounding all or part of the periphery of upper platen heating surface 16. As illustrated, skirts 36 and 38 are integrally formed from a single, monolithic strip of material to form unitary skirt 37, in which skirts 36 and 38 are affixed to one another at their adjoining corners. In an exemplary embodiment, the strip of material is joined at seam 39 formed on distal skirt portion 36. Thus, upward or downward movement of any of skirts 36 or 38 urges corresponding upward or downward movement of the entire skirt assembly. In this embodiment, slots 40 may be provided only on side skirts 38, as best illustrated in FIG. 3E.

In another alternative embodiment shown in FIGS. 3F and 3G, the steam-loss-prevention function of the peripheral barrier provided by skirts 36, 38 may be achieved using a flexible, high temperature fabric band 37A. As illustrated, fabric band 37A can be formed as one piece construction which extends around the four outer walls around the perimeter of upper platen assembly 12. Fabric band 37A is formed as an elongate strip of high-temperature fabric, folded along its length around wire 41.

To close the loop of the fabric band 37A, seam 39A is provided in the vicinity of distal surface 64. Similarly, hem 45 may be provided to capture wire 41 within an enclosed pocket formed by the folded longitudinal strip of fabric band 37A. Openings 43A are provided at periodic intervals at hem 45 band 37A (or, alternatively in cutouts provided at the fold), through which a portion of wire 41 is pulled to form wire attachment points 41A.

Fasteners 42 are passed through attachment points 41A and into upper platen assembly 12, in a similar fashion as described above. Flexible skirt 37A is positioned to contact heating surface 18 of lower platen 14 when upper platen assembly 12 is lowered into its lower position, in similar fashion as described above with respect to skirts 36, 38. Such high temperature fabric or other flexible material allows skirt 37A to easily conform to lower heating surface 18, even if surfaces 16, 18 are not parallel, while also allowing upper platen assembly 12 to rest upon or above the food product being cooked.

### 3. Discrete Cooking Surfaces

Turning now to FIG. 7, alternative cooking appliance 110 is shown. Cooking appliance 110 may include spacers 20 and/or skirts 36, 38 as described above. Except as otherwise noted herein, cooking appliance 110 is substantially similar to cooking appliance 10 described above, with reference numerals used to refer to components of cooking appliance 110 analogous to corresponding structures in cooking appliance 10, except with 100 added thereto.

Cooking appliance 110 includes a plurality of discrete (i.e., discontinuous) lower platens 114, configured as griddles in the illustrated embodiment. Discrete lower platens 114 are thermally isolated from one another and sized to engage a single upper platen 112, rather than being formed as a large unitary lower platen 14 spanning multiple upper platens 12 as shown in FIG. 1 and described above. Upper platens 112 are similar to platens 12 described above, and may be provided in either heated or unheated arrangements. In an exemplary embodiment, respective pairs of upper and lower platens 112, 114 are sized and shaped such that a periphery of upper platen heating surface 116 corresponds with and substantially overlays a periphery of the opposing lower platen heating surface 118. Stated another way, each respective opposed pair of upper and lower platens 112, 114 are similarly sized and shaped to mate with one another without substantial overlap.

In this arrangement, discrete lower platens 114 cooperate with upper platens 112 to provide selectively actuatable griddle areas which are thermally isolated from one another. This thermal isolation facilitates the production of griddled food product on demand from a single, unitary cooking appliance 110. For example, cooking appliance 110 facilitates the production of small batches of similar food product or small batches of different food products simultaneously. In addition, temperature may be individually and accurately controlled at each pair of upper and lower platens 112, 114 by controlling the heating element or elements within each respective pair of upper and lower platens 112, 114. In the illustrated embodiment of FIG. 7, control units 186 are affixed to or embedded into work top 102 to facilitate manual control of the individual heating elements of each pair of upper and lower platens 112, 114. As shown, one control unit 186 is provided to control each respective pair of upper and lower platens 112, 114, though it is also contemplated that a single control unit 186 can be wired to control all upper and lower platens 112, 114 within work top 102. This individualized control facilitates differing heating and cooking outputs from each pair of upper and lower platens 112, 114, thereby allowing the cooking of different foods within each discrete cooking space defined by respective pairs of upper and lower heating surfaces 116, 118.

The discrete, thermally isolated nature of lower platens 114 avoids any bleeding of thermal energy between adjacent lower heating surfaces 118, thereby conferring precise control over the food cooking parameters at each respective pair of upper and lower platens 112, 114. In addition, a discrete heat source for each lower platen 114 may be used to confer differing heating characteristics among respective pairs of upper and lower platens 112, 114. For example, one such pair can use an electric heating element while another pair can use a gas heating element. This arrangement may be desirable, for example, in instances where different opposing pairs of upper and lower platens 112, 114 are desired to have different cooking characteristics within the adjacent but discrete cooking stations supported by work top 102.

The above described structure and function can be achieved all in a single, unitary cooking appliance 110 having a monolithic work top 102 which houses multiple lower platens 114. More particularly, monolithic work top 102 may be made to minimize heat conduction from one lower platen 114 to another. In one embodiment, heat conduction may be minimized by minimizing surface area contact between work top 102 and lower platen 114, such as by providing a thin lip in apertures formed in work top 102 to support each lower platen 114. In this embodiment, work top 102 may be made of an otherwise conductive material such as stainless steel, and may optionally utilize further insulating material at the undersurface work top 102 between respective lower platens 114 to inhibit heat transfer therebetween. In another embodiment, work top 102 may be made from a non-heat-conducting material which thermally insulates lower platens 114 from one another, while also binding lower platens 114 into a single unit. With the heat transfer capability between platens 114 thus minimized, when one of lower platens 114 is in a cooled (i.e., “off”) state, the adjacent lower platen 114 can be heated without loss of the relatively hotter lower platen 114 transferring heat to the adjacent cooled lower platen 114. When less than all lower platens 114 are needed, only the energy needed for the platens 114 in use is used.

In use, work top 102 may be situated above the supporting ground surface to thereby elevate lower platens 114 to a suitable height for convenient operation by a standing worker. This allows workers in a high-throughput kitchen environment to place, manipulate and remove various food items from lower platen heating surface 118 while standing upright and moving around work top 102.

Cooking appliance 10, shown in FIGS. 1-3 and described above, may also utilize discrete lower platens similar to platens 114 in cooperation with upper platens 12.

### 4. Vertically Adjustable Platen

Referring still to FIG. 7, cooking appliance 110 also includes vertical adjustment mechanism 126 operable to raise and lower upper platen assembly 112 along a substantially vertical path, as opposed to the pivoting path of upper platen assembly 12 shown in FIG. 1 and described above. Vertical adjustment mechanism 126 includes actuator 180, which selectively raises and lowers mounting arm 182. Mounting arm 182 is affixed to upper platen assembly 112, such that actuation of actuator 180 operates to raise or lower upper platen assembly 112 along a substantially linear, vertical path of movement. In the illustrated embodiment of FIG. 7, control units 186 are electrically, operably connected to respective actuators 180 to provide a user interface for actuation of actuator 180. As noted above, control units 186 may be provided for each upper platen 112, or a single control unit 186 may control all upper platens 112 connected to work top 102, which has an upper work surface of suitable size and position for a standing user to manipulate the functions of cooking appliance 110 as described below.

Actuator 180 is contained within actuator housing 184, which is situated upon and above work top 102 and distal of upper and lower platens 112, 114. Thus, actuator 180 extends upwardly from work top 102 such that no part of actuator 180 or housing 184 extends below work surface 102, leaving the space beneath work surface 102 available for other uses. For example, coolers containing the food items to be cooked using cooking appliance 110 may be stored underneath work top 102, thereby placing such food items within easy reach of the operator of cooking appliance 110. This, in turn, can minimize unnecessary movement of the operator around the work area, maximizing potential throughput of cooked food items from cooking appliance 110. In addition, the placement of actuator 180 and housing 184 above work surface 102 facilitates cleaning thereof.

Actuator 180 may be any of a variety of linear actuators as required or desired for a particular application. For example, actuator 180 may utilize a rack and pinion mechanism to raise and lower mounting arm 182 along a linear or arcuate path. A ball screw and bronze nut assembly may be used in actuator 180 to convert rotation of a motor mandrel into a controlled, accurate raising and lowering motion of mounting arm 182. Fluid-powered linear actuators, such as air or hydraulic cylinders, may also be used.

The vertical travel of upper platen assembly 112 avoids excessive outward radiation of heat from upper heating surface 116 when upper platen assembly 112 is in the elevated, open position (i.e., the cooking space is unbounded because no significant transfer of heat can occur between upper and lower heating surfaces 116, 118). Instead, upper heating surface 116 remains in a downwardly facing, mutually opposed orientation with respect to lower heating surface 118 of lower platen 114 even when in an opened configuration. This arrangement avoids sudden upward movement of heat and/or steam from the surface of upper heating surface 116 upon lifting upper platen assembly 112, which preserves energy and protects the operator from exposure to the same. This steam control and retention offered by upper platen assembly 112 has particular utility when upper platen assembly 112 is used with an efficiency skirt assembly described above in section 2 of the present application, as a substantial quantity of steam may be retained between upper and lower platens 112, 114 prior to opening.

The vertical path of upper platen assembly 112 may be substantially linear, such that upper heating surface 116 remains substantially parallel to lower heating surface 118 as upper platen assembly 112 is raised and lowered. Stated another way, no significant rotation of upper heating surface 116 occurs as upper platen assembly 112 is raised and lowered through a range of travel.

Once upper platen assembly 112 is raised to the top of the vertical travel, i.e., above lower platen 114 by a desired amount, the path of upper platen 112 may optionally include a backward pivoting motion, similar to the pivoting motion of upper platen 12 shown in FIG. 1 and described above. This backward rotation may pivot upper platen 112 away from the user, thereby providing unobstructed access to heating surface 118 of lower platen 114. This backward rotation may be effected by a hinge mounted between vertical actuator 180 and upper platen assembly 112, or vertical actuator 180 may itself incorporate the backward rotation functionality. For example, where vertical actuator 180 is a rack and pinion arrangement, the rack which defines the vertical motion of upper platen assembly 112 may have a backward bend built into its upper portion. Other linear actuation mechanisms, such as those described above, may have similar backward and rotated paths to effect a desired backward rotation of upper platen 112.

Cooking appliance 10, shown in FIGS. 1-3 and described above, may also utilize vertical adjustment mechanism 126 in addition to, or in lieu of assist cylinder 26 and the associated pivotal attachment components shown in FIG. 1 and described in detail above.

In both of cooking appliances 10 and 110, it is contemplated that heat may be imparted to either the upper platen assembly 12, 112 or the lower platen 14, 114, but not both. It is also contemplated that a controller of the type disclosed above with respect to section 1 of the present application may be utilized in conjunction with other features of the present cooking devices, and may be operable to actuate actuators for vertical adjustment mechanism 126 and/or skirts 36, 38, and may individually control heating of discrete lower platens 114.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A cooking appliance comprising:
a first platen having a first platen cooking surface;
a second platen having a second platen cooking surface opposed to and spaced from said first platen cooking surface to define a cooking space between said mutually opposed first and second cooking surfaces;
a heating element in at least one of said first platen and said second platen; and
a skirt assembly connected to said first platen and arranged at a periphery of said cooking space, said skirt assembly extending away from said first platen cooking surface toward said second platen cooking surface, whereby said skirt assembly operates as a barrier to an escape of steam from said cooking space.

2. The cooking appliance of claim 1, wherein said skirt assembly rests upon said second platen cooking surface.

3. The cooking appliance of claim 1, wherein said skirt assembly comprises:
a proximal skirt disposed along a proximal end surface of said first platen such that said proximal skirt is positioned to be near a user of the cooking appliance;
a first side skirt disposed along a first lateral surface of said first platen and extending away from said proximal skirt;
a second side skirt disposed along a second lateral surface of said first platen and extending away from said proximal skirt, said second side skirt opposed to said first side skirt.

4. The cooking appliance of claim 3, wherein said first platen comprises an upper platen and said second platen comprises a lower platen, and
said proximal skirt, said first side skirt and said second side skirt are slidably mounted to said first platen.

5. The cooking appliance of claim 4, wherein said proximal skirt, said first side skirt and said second side skirt each include elongate slots, said skirt assembly including bolts received through said elongate slots and into said first platen to slidably mount said proximal skirt, said first side skirt and said second side skirt to respective surfaces of said upper platen.

6. The cooking appliance of claim 3, wherein said proximal skirt, said first side skirt, and said second side skirt each define lengths substantially equal to said proximal end surface, said first lateral surface and said second lateral surface respectively.

7. The cooking appliance of claim 3, further comprising at least one distal skirt disposed along a distal surface of said first platen and disposed at respective ends of said first and second side skirts, said at least one distal skirt cooperating with said proximal skirt and said first and second side skirts to substantially enclose said cooking space.

8. The cooking appliance of claim 1, wherein said first platen is configurable in a closed configuration in which said first and second platen cooking surfaces define said cooking space and an open position in which said cooking space is unbounded,
said cooking appliance further comprising a spacer attached to said first platen and extending away from said first platen cooking surface and toward said second platen cooking surface, said spacer positioned to define a size of said cooking space when said first platen is in said closed configuration.

9. The cooking appliance of claim 1, wherein said first platen comprises an upper platen and said second platen comprises a lower platen, the cooking appliance further comprising a vertical actuator operably connected to said upper platen, said vertical actuator operable to raise and lower said upper platen along a vertical path between an open configuration and a closed configuration.

10. The cooking appliance of claim 1, wherein said first platen comprises an upper platen and said second platen comprises a lower platen, the cooking appliance further comprising:
a support structure having a work top supporting said lower platen, said lower platen comprising a plurality of discrete, thermally isolated platens disposed within said work top.

11. The cooking appliance of claim 1, wherein said first platen comprises a frame structure, including side plates interconnected by a proximal plate and a distal plate, said skirt assembly slidably attached to said frame structure.

12. The cooking appliance of claim 1, wherein said skirt assembly comprises a monolithically formed strip of material.

13. The cooking appliance of claim 1, wherein said skirt assembly comprises a flexible strip of material folded around a wire, said wire protruding outwardly from said fold at selected locations to form attachment points at which said skirt assembly is connected to said first platen.

14. A cooking appliance comprising:
an upper platen having an upper platen cooking surface;
a lower platen having a lower platen cooking surface opposed to and spaced from said upper platen cooking surface to define a cooking space between said mutually opposed upper and lower cooking surfaces;
a heating element in at least one of said upper platen and said lower platen; and
a spacer adjustably attached to said upper platen and extending downwardly past said upper platen cooking surface toward said lower platen cooking surface, said spacer adjustable to a first position and a second position, said spacer defining a first cooking space size in said first position and a second cooking space size in said second position, said first cooking space size different from said second cooking space size.

15. The cooking appliance of claim 14, wherein said spacer is slidably mounted to said upper platen, whereby said spacer defines a continuously adjustable cooking space size between said first cooking space size and said second cooking space size.

16. The cooking appliance of claim 15, wherein said spacer is secured to said upper platen by a fastener received in an elongated slot formed in said spacer, said elongated slot moveable with respect to said fastener to provide said slidably mounted arrangement.

17. The cooking appliance of claim 14, wherein said spacer comprises three spacers spaced apart from one another about a periphery of said upper platen.

18. The cooking appliance of claim 17, wherein two of said three spacers are respectively arranged near opposing ends of a proximal surface of said upper platen, and a third of said three spacers is substantially centered on a distal surface of said upper platen, whereby said three spacers provide a stable three point support system for said upper platen cooking surface relative to said lower platen cooking surface.

19. The cooking appliance of claim 14, further comprising a skirt assembly arranged at a periphery of said upper platen, said skirt assembly extending away from said upper platen cooking surface toward said lower platen cooking surface, whereby said skirt assembly operates as a barrier to an escape of steam from said cooking space.

20. The cooking appliance of claim 14, further comprising a vertical actuator operably connected to said upper platen, said vertical actuator operable to raise and lower said upper platen along a vertical path while maintaining said upper and lower platen cooking surfaces in a substantially parallel configuration.

21. The cooking appliance of claim 14, further comprising a support structure having a work top supporting said lower platen, said lower platen comprising a plurality of discrete, thermally isolated platens disposed within said work top.

22. A cooking appliance comprising:
an upper platen having an upper platen cooking surface;
a lower platen having a lower platen cooking surface facing said upper platen cooking surface, said upper and lower platen cooking surfaces spaced from and substantially parallel to one another to define a cooking space therebetween;
a heating element in at least one of said upper platen and said lower platen; and
a vertical actuator operably connected to said upper platen, said vertical actuator operable to raise and lower said upper platen along a vertical path while maintaining said upper and lower platen cooking surfaces in said substantially parallel configuration.

23. The cooking appliance of claim 22, further comprising a support structure having a work top, said lower platen supported on or in said work top, and said vertical actuator situated upon said work top and extending upwardly from said work top.

24. The cooking appliance of claim 23, wherein no part of said vertical actuator extends below said work top, whereby a space beneath said work top is unoccupied by said vertical actuator.

25. The cooking appliance of claim 23, wherein said work top is made of a monolithic non-heat-conducting material, and said lower platen is one of a plurality of discrete, thermally isolated lower platens disposed within said work top.

26. The cooking appliance of claim 21, wherein said vertical actuator is one of a rack and pinion mechanism, a ball screw and bronze nut assembly, an air cylinder and a hydraulic cylinder.

27. The cooking appliance of claim 22, wherein said vertical actuator includes a backward bend at an upper portion thereof, such that said upper platen pivots away from the vertical path after said upper platen is raised by a desired amount along the vertical path.

28. The cooking appliance of claim 22, further comprising a hinged connection between said vertical actuator and said upper platen, such that said upper platen may be rotated to a further open position at the top of the vertical path.

29. The cooking appliance of claim 22, further comprising a skirt assembly arranged at a periphery of said upper platen, said skirt assembly extending downwardly from said upper platen cooking surface toward said lower platen cooking surface, whereby said skirt assembly operates as a barrier to an escape of steam from said cooking space when said upper platen is in a lowered position to define the cooking space.

30. The cooking appliance of claim 22, wherein said upper platen is configurable in a closed configuration in which said upper and lower platen cooking surfaces define said cooking space and an open position in which said upper platen has been moved upwardly along the vertical path,
said cooking appliance further comprising a spacer attached to said upper platen and extending downwardly away from said upper platen cooking surface and toward said lower platen cooking surface, said spacer positioned to define a size of said cooking space when said upper platen is in said closed configuration.

31. A cooking appliance comprising:
a support structure having a work top made of a monolithic material;
a plurality of lower platens supported on or in said work top and spaced from one another, said plurality of lower platens each having a lower platen cooking surface, said work top thermally isolating said plurality of lower platens from one another;
a plurality of upper platens each having an upper platen cooking surface respectively opposed to and spaced from one of said plurality of lower platen cooking surfaces to define a plurality of discrete, thermally isolated cooking spaces between respective pairs of opposed upper and lower cooking surfaces; and
a heating element in at least one of said upper platen and said lower platen for each of said respective pairs of opposed upper and lower cooking surfaces.

32. The cooking appliance of claim 31, wherein said work top is non-heat-conducting material.

33. The cooking appliance of claim 31, wherein each of said plurality of lower platens is sized to engage a single one of said plurality of upper platens, such that a periphery of each said upper platen cooking surface corresponds with and substantially overlays a periphery of each opposing said lower platen cooking surface.

34. The cooking appliance of claim 31, wherein one pair of opposed upper and lower cooking surfaces has a first one of said heating element, and another pair of opposed upper and lower cooking surfaces has a second one of said heating element, said first and second ones of said heating element being different from one another whereby respective pairs of said opposed upper and lower cooking surfaces have differing cooking characteristics.

35. The cooking appliance of claim 31, wherein said work top is situated at a height above a supporting ground surface suitable for operation by a standing worker.

36. The cooking appliance of claim 31, further comprising at least one control unit operably connected to each said heating element.

37. The cooking appliance of claim 31, further comprising a skirt assembly arranged at a periphery of at least one of said plurality of upper platens, said skirt assembly extending away from said upper platen cooking surface toward the opposed said lower platen cooking surface, whereby said skirt assembly operates as a barrier to an escape of steam from the respective cooking space.

38. The cooking appliance of claim 31, wherein each of said plurality of upper platens is configurable in a closed configuration in which an opposed pair of said upper and lower platen cooking surfaces define one of said plurality of discrete, thermally isolated cooking spaces, and each of said plurality of upper platens is configurable in an open position in which respective ones of said plurality of discrete, thermally isolated cooking spaces is unbounded,
the cooking appliance further comprising a spacer attached to at least one of said plurality of upper platens, said spacer extending downwardly away from said upper platen cooking surface and toward said opposing lower platen cooking surface, said spacer positioned to define a size of a respective cooking space when said at least one upper platen is in said closed configuration.

39. The cooking appliance of claim 31, wherein each of said plurality of upper platens is configurable in a closed configuration in which an opposed pair of said upper and lower platen cooking surfaces define one of said plurality of discrete, thermally isolated cooking spaces, and each of said plurality of upper platens is configurable in an open configuration in which respective ones of said plurality of discrete, thermally isolated cooking spaces is unbounded,
the cooking appliance further comprising a vertical actuator operably connected to at least one of said plurality of upper platens, said vertical actuator operable to raise and lower said at least one upper platen along a vertical path between said open configuration and said closed configuration.
